(19) United States
(12) Patent Application Publication
(10) Pub. No.: US 2013/0246149 A1
(43) Pub. Date: Sep. 19, 2013

(54) AUTHENTICATION AND DELIVERY OF AN ELECTRONIC BOOK

(71) Applicants: KEVIN WEISS, Bloomington, IN (US); Keith Ogorek, Indianapolis, IN (US)

(72) Inventors: KEVIN WEISS, Bloomington, IN (US); Keith Ogorek, Indianapolis, IN (US)

(73) Assignee: Author Solutions Inc., Bloomington, IN (US)

(21) Appl. No.: 13/418,634

(22) Filed: Mar. 13, 2012

(51) Int. Cl. G06Q 30/02

(52) U.S. Cl. 705/14.26

(57) ABSTRACT

A server device includes a memory and a processor communicatively coupled to the memory. The processor is configured to execute instructions associated with permitting searching of an electronic book profile of a desired electronic book by a user based on a predetermined search code provided thereto, and providing a search result based on the searching of the electronic book profile such that a non-discount price of the desired electronic book is presented to the user. The processor is also configured to execute instructions associated with authenticating the user based on a unique promotional code such that the desired electronic book is downloadable to an electronic device by the user, and resetting the non-discount price to a discount price less than the non-discount price associated with the desired electronic book based on tracking interaction of the user with a number of electronic book profiles.

### FIELD OF TECHNOLOGY

This disclosure relates generally to electronic books and more particularly, to authentication and delivery of an electronic book.

### BACKGROUND

Electronic books (e-books) may provide a cost efficient and environment-friendly way to access, download and/or read content from multiple authors on a single electronic device (e.g., iPad®, Kindle®, etc.). As a part of a marketing campaign, a party may want potential users to have access to and to read one or more promotional copies of electronic books in the hope that the user will return and purchase other electronic books from the same party.

In the past, this type of marketing campaign was limited to physical paper books that were handed out to potential users at conferences, bookstores, etc. Carrying a huge number of physical paper books to different locations can be costly and cumbersome due to problems associated with weight, cost, transportation, size and space. An easy, cost efficient and environment-friendly method of implementing the same marketing campaign may involve providing potential users and readers with a small card having a unique promotional code that entitles the holder of the card to access, download and read a promotional book in electronic format. These small cards (much like a key fob for a hotel room) may be carried with ease, are easy to produce and manufacture, are cost efficient, and do not pose a threat to the environment. They can easily be placed by a user in his/her purse, wallet or pocket, and may be redeemed if and when the user is ready to download and read the free and/or promotional copy of the electronic book.

Upon redemption by the user, this format of distributing promotional electronic books may also provide the party with a rich collection of relevant and precise information about the user, the user's location, his/her reading habits, etc. This information may be used by the party to market other books to the user/reader based on the user's interest level, likes and dislikes, preferences for certain authors and subject matters/genres to others and/or frugality in terms of paying for electronic books.

This level of user-generated and user-specific information may not available to authors and publishers if they distribute physical paper copies of promotional books. Once given to the user and/or reader, the author and/or publisher may lose track of the user forever and may never hear back from the user. They may also not have user-centric information for future marketing and sales campaigns targeted to a specific user.

### SUMMARY

Disclosed are methods, an apparatus and/or a system of authentication and delivery of an electronic book.

In one aspect, a server device includes a memory and a processor communicatively coupled to the memory. The processor is configured to execute instructions associated with permitting searching of an electronic book profile of a desired electronic book on the server device by a user based on a predetermined search code provided to the user based on the electronic book profile, and providing a search result based on the searching of the electronic book profile of the desired electronic book such that a non-discount price associated with the desired electronic book is presented to the user. The server device also includes authenticating the user based on a unique promotional code associable with the electronic book profile such that the desired electronic book is downloadable to an electronic device by the user upon entering of the unique promotional code, and resetting the non-discount price associated with the desired electronic book to a discount price that is less than the non-discount price associated with the desired electronic book based on tracking interaction of the user with a number of electronic book profiles such that the discount price is adjusted based on an interest level of the user associated with a number of desired electronic books related to the number of electronic book profiles.

In another aspect, a method includes permitting searching of an electronic book profile of a desired electronic book on a server device by a user thereof based on a predetermined search code provided to the user based on the electronic book profile, and providing, through the server device, a search result based on the searching of the electronic book profile of the desired electronic book such that a non-discount price associated with the desired electronic book is presented to the user. The method also includes authenticating the user based on a unique promotional code associable with the electronic book profile such that the desired electronic book is downloadable to an electronic device by the user upon entering of the unique promotional code, and resetting, through the server device, the non-discount price associated with the desired electronic book to a discount price that is less than the non-discount price associated with the desired electronic book based on tracking interaction of the user with a number of electronic book profiles such that the discount price is adjusted based on an interest level of the user associated with a number of desired electronic books related to the number of electronic book profiles.

The methods and systems disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a schematic view of entering of a predetermined search code by a user of a server device to locate a desired electronic book from an electronic book profile resident on the server device, according to one or more embodiments.

FIG. 2 is a schematic view illustrating presentation of a non-discount price of the desired electronic book to the user, according to one or more embodiments.

FIG. 3 is a schematic view of entering of a unique promotional code associated with a desired electronic book and presentation of the desired electronic book for downloading by the user, according to one or more embodiments.

FIG. 4 is a schematic view of downloading of the desired electronic book to an electronic device of the user, according to one or more embodiments.

FIG. 5 is a schematic view of calculation of frugality of the user and an appropriate recommendation of desired electronic books based on a subsequent interaction of a user profile with an electronic book profile and with a number of desired electronic books, according to one or more embodiments.

FIG. 6 is a table showing the price outcome of a desired electronic book based on interest level of the user and frugality level thereof, according to one or more embodiments.

FIG. 7 is a schematic view of tracking of user behavior based on the subsequent interaction(s) of the user, according to one or more embodiments.

FIG. 8 is a user-interface view of a promotional electronic book card with a predetermined search code and a unique promotional code to download a desired electronic book, according to one or more embodiments.

FIG. 9 is a process flow diagram detailing the operations involved in a method of authentication and delivery of an electronic book, according to one or more embodiments.

FIG. 10 is a schematic view of a generic computer system with a non-transitory memory and a processor, wherein any of the embodiments described herein may be performed.

Other features of the present embodiments will be apparent from the accompanying drawings and from the detailed description that follows.

### DETAILED DISCLOSURE

Example embodiments, as described below, may be used to provide a method, a system and/or an apparatus of authentication and delivery of an electronic book. Although the present embodiments have been described with reference to specific example embodiments, it will be evident that various modifications and changes may be made to these embodiments without departing from the broader spirit and scope of the various embodiments.

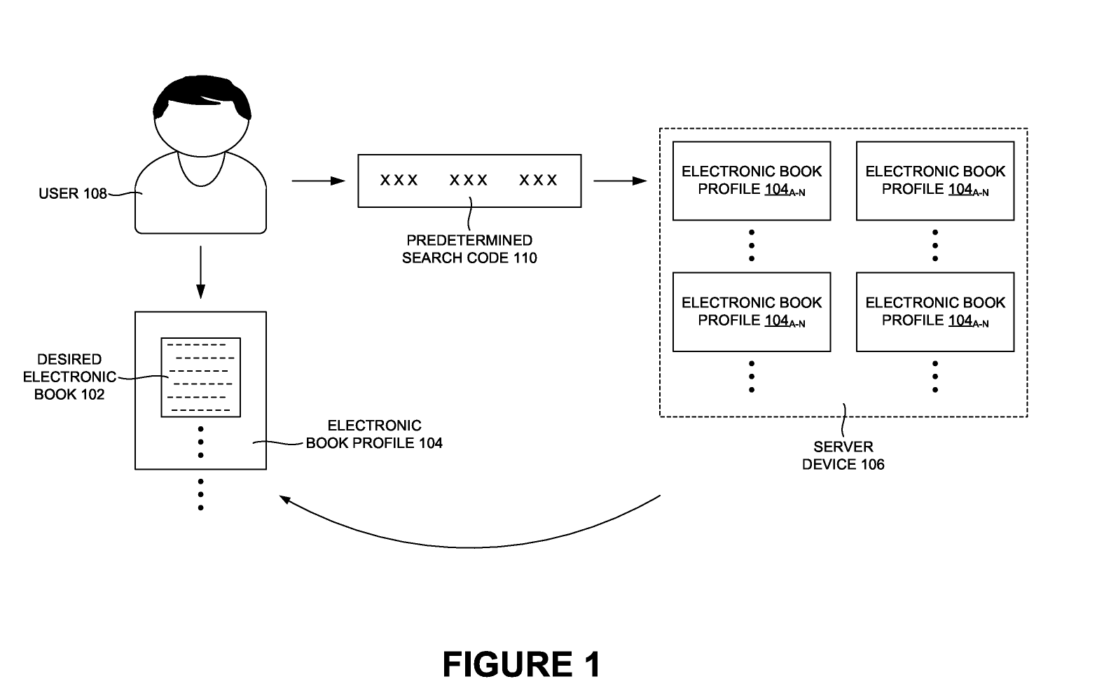

FIG. 1 illustrates entering of a predetermined search code 110 by a user 108 of server device 106 to locate a desired electronic book 102 from an electronic book profile 104 resident on the server device 106, according to one or more embodiments. One or more electronic book profiles 104 A-N may be resident on the server device 106, according to one embodiment. According to another embodiment, each electronic book profile 104 may contain one or more desired electronic books 102 and the predetermined search code 110 may be applicable to just one electronic book 102 associable with one electronic book profile 104. The predetermined search code 110 may be provided to the user 108 by a party (e.g., an author, a publisher, a bookstore, or any other party, entity, and/or organization) at a conference, a bookstore, a live event, etc., according to one or more exemplary embodiments. Other ways of providing the predetermined search code 110 are within the scope of the exemplary embodiments.

Once entered by the user 108, the predetermined search code 110 may act as a locator to locate the desired electronic book 102 associated with the predetermined search code 110 from an electronic book profile 104, according to one or more embodiments. This location function may employ any search methodology used for searching databases and other information location systems in server device 106, according to another embodiment. It will be appreciated that a single predetermined search code 110 may be associable with and may be able to locate multiple desired electronic books 102 A-N from multiple electronic book profiles 104 A-N, according to one or more exemplary embodiments.

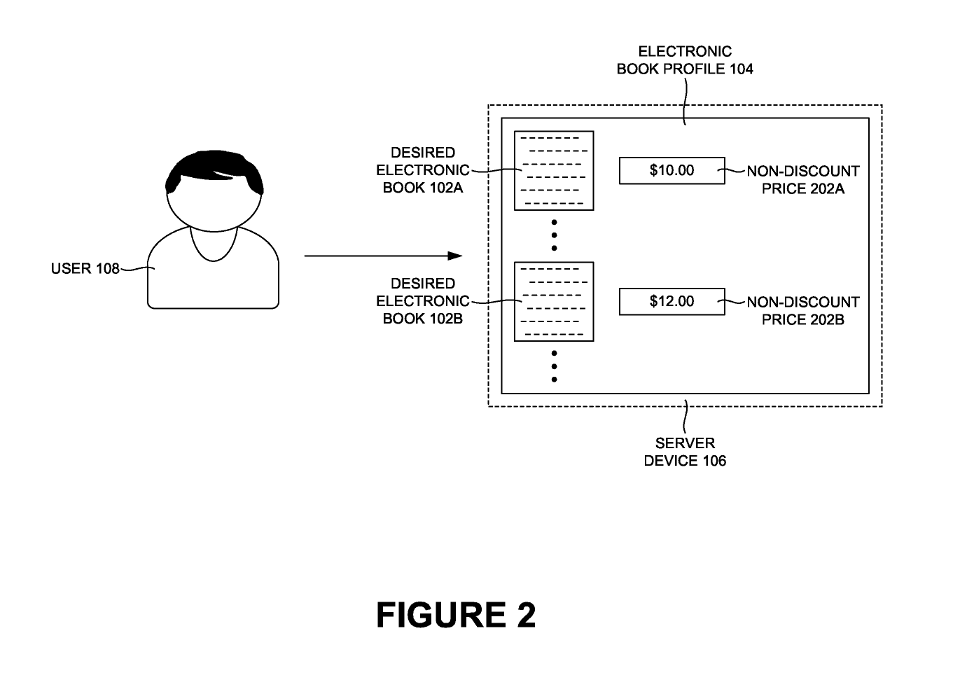

FIG. 2 illustrates the presentation of the non-discount price 202 of the desired electronic book 102 to the user, according to one or more embodiments. Once the user 108 is able to locate the desired electronic book 102 upon entering the predetermined search code 110, the user may be presented with a non-discount price 202 of the electronic book 102, according to one or more embodiments. For example, a non-discount price of 202A associated with desired electronic book 102A and a non-discount price 202B associated with desired electronic book 102B may be presented to the user 108. The purpose of the aforementioned presentation of the non-discount price 202 of the desired electronic book 102 to the user 108 may involve raising user (e.g., user 108) awareness of the true and/or actual cost of the desired electronic book 102.

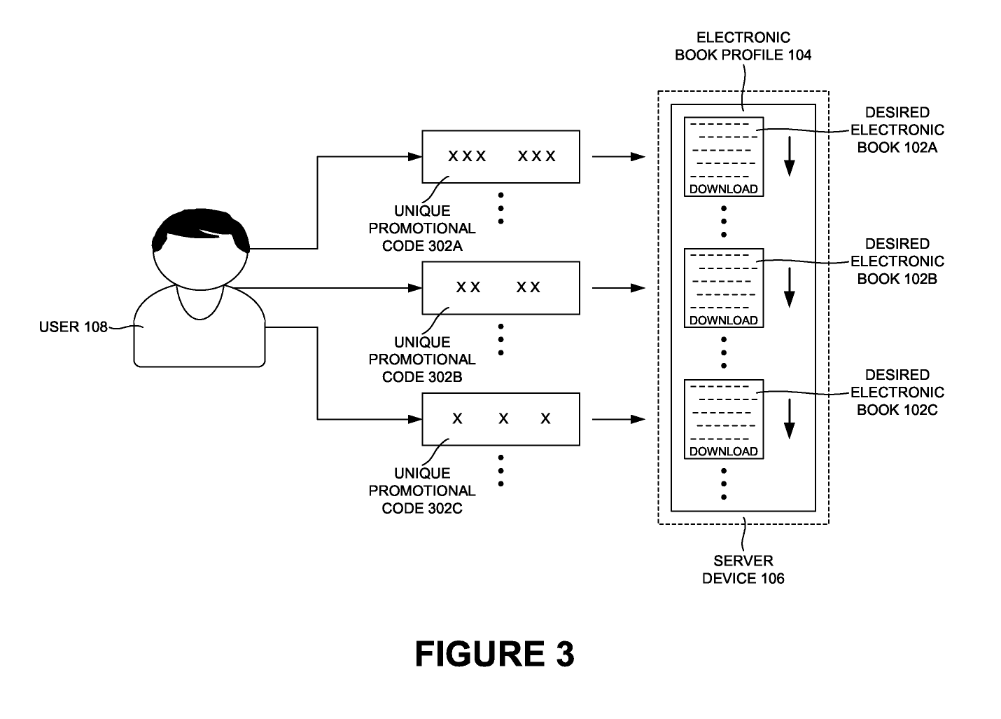

According to one or more exemplary embodiments, the user 108 may be authenticated based on a unique promotional code 302 (refer to FIG. 3) associable with the electronic book profile 104 such that the desired electronic book 102 may be downloadable by the user 108 upon entering of the unique promotional code 302. The unique promotional code 302 may authenticate the user 108 based on the user 108's selection of a desired electronic book 102, according to one or more embodiments. According to one or more illustrative examples, multiple unique promotional codes 302 A-N may be associable with multiple desired electronic books 102 A-N within one or more electronic book profiles 104. The unique promotional code 302 may, from time to time, be offered to one or more users 108 such that unique promotional code 302 A-N may only be applied to purchases made through the account in respect of which the unique promotional code 302 was offered and registered, according to one or more embodiments.

FIG. 3 illustrates the entering of the unique promotional code 302 associated with a desired electronic book 102 and the presentation of the desired electronic book 102 for downloading by the user 108, according to one or more embodiments. The unique promotional code 302 may be set up within a user 108 type (e.g., on a user profile 502) to subtract a specific monetary amount or percentage off the non-discount price 202 of the desired electronic book 102, according to one or more embodiments. All desired electronic books 102 A-N may be a part of the same electronic book profile 104 or may be part of a number of electronic book profiles 104 A-N, according to one or more exemplary embodiments.

According to one or more embodiments, a discount module (not shown) may be implemented in server device 106 to reset the non-discount price 202 associated with the desired electronic book 102 to a discount price 402 that may be less than the non-discount price 202 associated with the desired electronic book 102. According to an exemplary embodiment, a download module (not shown) implemented on server device 106 may permit the downloading of the desired electronic book 102 to an electronic device 404 of the user 108. A tracking module (not shown) implemented on server device 106 may track a subsequent interaction of the user 108 with a number of electronic book profiles 104 A-N such that the discount price 402 may be adjusted based on an interest level 504 of the user 108 associated with a number of desired electronic books 102 A-N, according to one or more illustrative and exemplary embodiments.

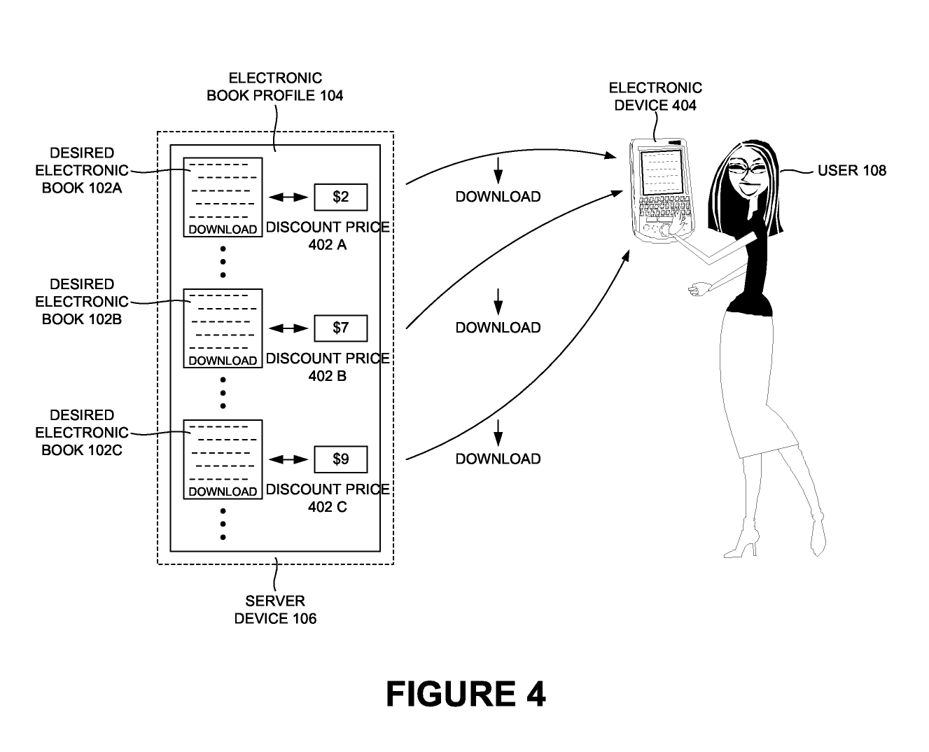

FIG. 4 illustrates the downloading of the desired electronic book 102 to an electronic device 404 of the user 108, according to one or more embodiments. The desired electronic book 102 may be downloaded to any electronic device 404 of the user 108. Examples of the electronic device 404 include an iPad®, a Kindle®, a Nook® etc. The discount price 402 may be adjusted based on an interest level 504 of the user 108 associated with a number of desired electronic books 102 A-N. This adjustment may happen after a subsequent interaction of the user 108 with one or more electronic book profiles 104 A-N, according to one or more illustrative examples.

It will be appreciated that, according to one or more embodiments, the search module (not shown) may be configured to locate fragments of a number of electronic book profiles 104 A-N based on a user profile 502 such that a subsequent interaction with the user 108 to track an interest level 504 of the user 108 may be associable with a number of desired electronic books 102 A-N. The fragments of the number of electronic book profiles 104 A-N based on the interest level 504 of the user 108 and the corresponding user profile 502 may also be modified, according to one embodiment. It will also be appreciated that, according to one or more exemplary embodiments, a price module (not shown) may make an association between the non-discount price 202 associated with the desired electronic book 102 and a frugality level 506 associable with a user profile 502 such that the non-discount price 202 associated with the desired electronic book 102 may be reduced prior to being presented to the user 108 if and when the user 108 subsequently interacts with a number of electronic book profiles 104 A-N.

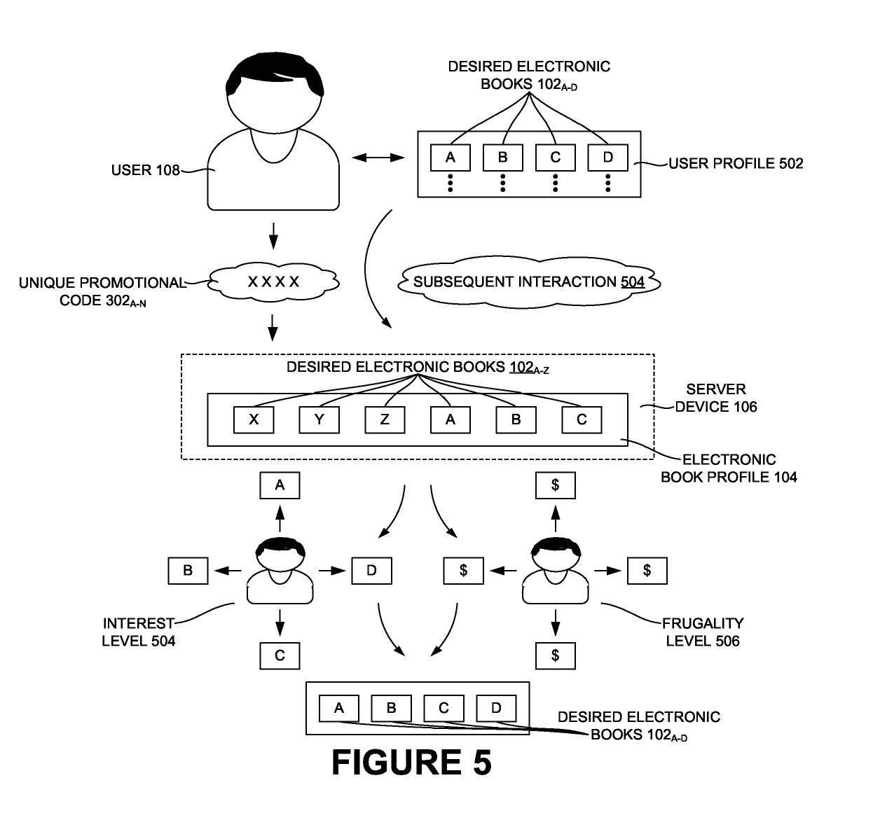

FIG. 5 illustrates the calculation of the frugality level 506 of the user 108 and an appropriate recommendation of desired electronic books 102 A-N based on a subsequent interaction of a user profile 502 (associated with user 108) with an electronic book profile 104 and/or with a number of desired electronic books 102 A-N, according to one or more embodiments. The user 108 may enter one or more unique promotional codes 302 A-N based on his/her desired electronic books 102 A-N. Upon a subsequent interaction of the user 108 with an electronic book profile 104 (e.g., which may have a number of desired electronic books 102 A-N), the user 108's interest level 504 and frugality level 506 may be calculated and/or determined based on the user 108's subsequent interaction, according to one or more embodiments. The user 108 may have a different interest level 504 in electronic book 102A versus electronic book 102N. The user 108's frugality level 506 may also vary between different electronic books 102 A-N. Based on the user 108's interest level 504 and frugality level 506, a recommendation may be made to the user selecting and/or ranking particular electronic books (e.g., desired electronic books 102 A-D in FIG. 5), according to one or more exemplary embodiments.

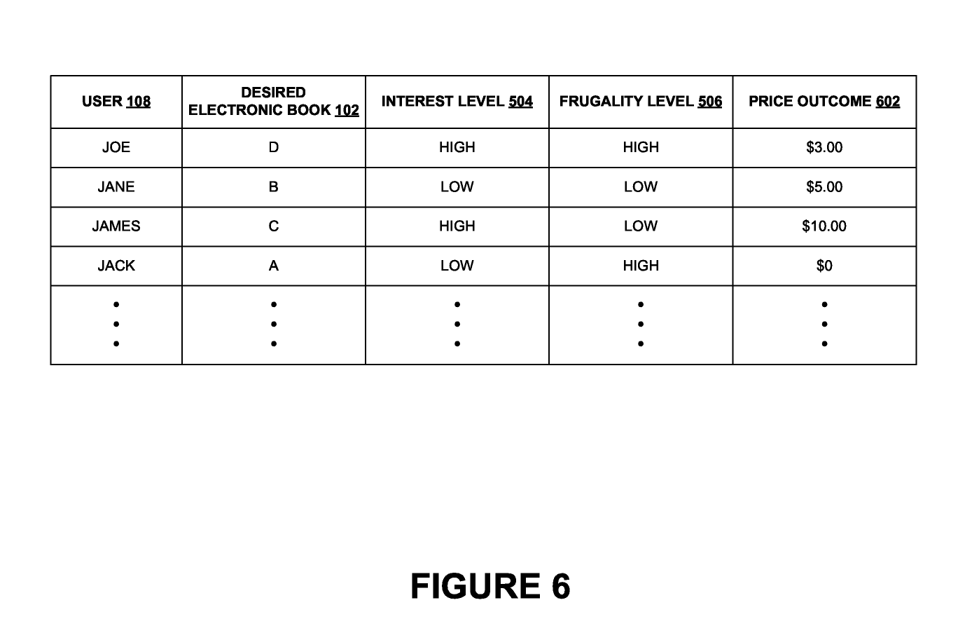

FIG. 6 shows a table view of the price outcome 602 of a desired electronic book 102 based on user 108's interest level 504 and frugality level 506, according to one or more embodiments. According to an illustrative example, Joe may want desired electronic book 102D and his interest level 504 in desired electronic book 102D may be high. However, his frugality level 506 may also be high, which means that Joe may not want to pay the non-discount price 202 for desired electronic book 102D. Therefore, the price outcome 602 may be adjusted to $3.00 (significantly less than the non-discount price 202D) based on Joe's interest level 504 and frugality level 506 as associable with desired electronic book 102D.

Similarly, and according to one or more embodiments, James may want desired electronic book 102C and his interest 504 in desired electronic book 102C may be high. However, his frugality level 506 in desired electronic book 102C may be low, which means that James may not mind paying a price that is close to the non-discount price 202C (albeit a bit lower), according to an illustrative example. Thus, the price outcome 602 may be adjusted to $10.00 (not significantly less than the non-discount price 202C) based on James' interest level 504 and frugality level 506 as associable with desired electronic book 102C.

According to an illustrative embodiment, Jane may want desired electronic book 102B, but her interest 504 in desired electronic book 102B may be low. Her frugality level 506 in desired electronic book 102B may also be low, which means that Jane may not want to pay a price that is close to the non-discount price 202B (she may want a much lower price as a motivation to purchase), according to an illustrative example. Thus, the price outcome 602 may be adjusted to $5.00 (moderately less than the non-discount price 202B) based on Jane's interest level 504 and frugality level 506 as associable with desired electronic book 102B.

Jack, on the other hand, may want desired electronic book 102A but his interest 504 in desired electronic book 102B may be low, according to an illustrative example. However, his frugality level 506 in desired electronic book 102A may be high, which means that Jack may need a very low discount price 402 (e.g., close to zero or free/promotional level) to download the desired electronic book 102A. Thus, the price outcome 602 may be adjusted to $0.00 based on Jack's interest level 504 and frugality level 506 as associable with desired electronic book 102A.

According to one or more exemplary embodiments, the authentication module (not shown) may be configured to automatically populate the predetermined search code 110 such that the unique promotional code 302 may be used to create a number (e.g., practically infinite) of predetermined search codes 110 A-N associable with a number of electronic book profiles 104 A-N. In addition, and according to another embodiment, the download module (not shown) may be configured to permit the downloading of the desired electronic book 102 in a number of file formats associable with a number of electronic devices 404 A-N (e.g., iPad®, Kindle®, Nook® etc.). According to an illustrative example, the user 108 may be permitted to select the file format most appropriate and/or compatible with the user 108's electronic device 404 (e.g., a .pdf file format, an .epub file format, a .mobi file format etc.). As mentioned above, and according to one embodiment, the tracking module (not shown) may be used to track user 108's behavior based on a subsequent interaction of user 108 with a number of electronic book profiles 104 A-N.

According to one or more embodiments, a method may comprise permitting a search function of an electronic book profile 104 of a desired electronic book 102 searchable on the server device 106 such that a user 108 may be capable of locating the desired electronic book 102 by entering a predetermined search code 110 provided to the user 108 based on the electronic book profile 104. The user 108 may be authenticated based on a unique promotional code 302 associable with the electronic book profile 104 such that the desired electronic book 102 may be downloadable by the user 108 upon entering of the unique promotional code 302, according to one or more embodiments. One or more authentication methods implemented may be based on but not limited to: passwords, one-time passwords, public-key cryptography, zero-knowledge proofs, digital signatures, authentication protocols such as secure socket layer, IP SEC, secure shell and Kerberos.

The user 108 may be provided with a link to download the desired electronic book 102 to an electronic device 404 of the user 108, according to one or more embodiments. The link may be in the form of an email message, a text message, or any other form of internet and/or mobile device based communication. The link may also be generated automatically and may be presented to user 108 on a secure website. The behavior of the user 108 may then be tracked based on a subsequent interaction of the user 108 with a number of electronic book profiles 104 A-N, according to one or more embodiments. According to an illustrative example, the behavior of the user 108 may be associable with factors including but not limited to: an author 702, a title 704, a genre 706, an electronic book length, a complexity level, a text-to-image ratio, and/or a language 708 of the desired electronic book 102 such that a number of electronic book profiles 104 A-N matching the behavior of the user 108 may be presented to the user 108 upon subsequent interaction of the user 108 with the number of desired electronic books 102 A-N.

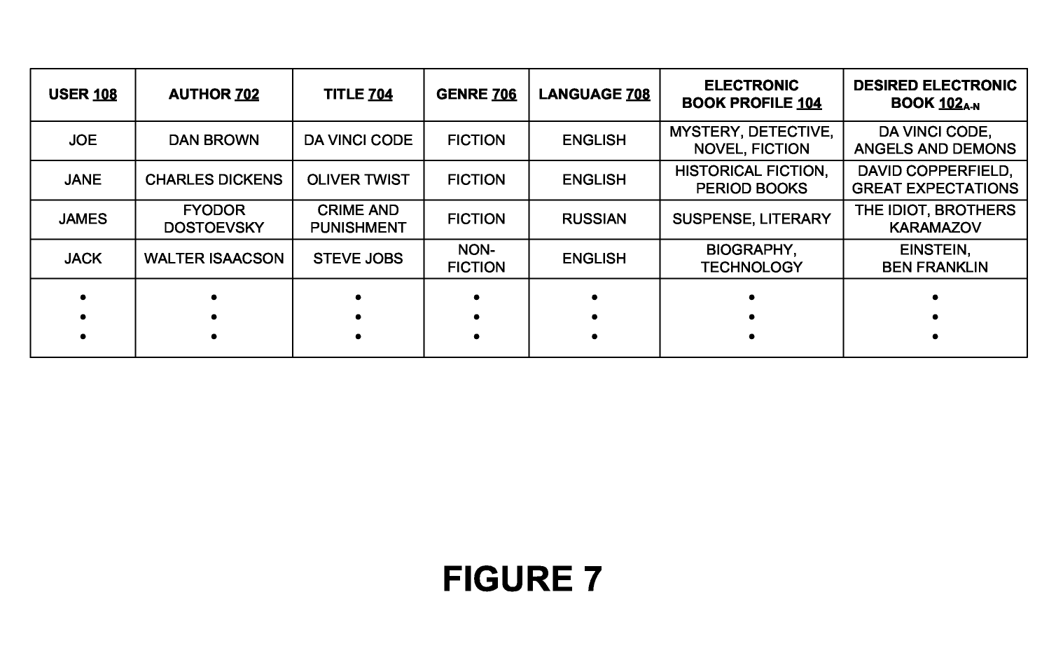

FIG. 7 illustrates tracking of the behavior of the user 108 based on a subsequent interaction of the user 108, according to one or more embodiments. According to an illustrative example, Joe may desire Dan Brown novels, and in particular, Da Vinci Code. Based on Joe's preferred and/or desired genre 706 and language 708, an electronic book profile 104 including mystery, detective novels and fiction may be associated with Joe. Subsequently, desired electronic books 102 A-N consisting of Dan Brown novels such as Da Vinci Code and Angels and Demons may be presented to be downloaded by Joe. It will be appreciated that the tracking module (not shown) may work seamlessly with Joe's interest level 504 and frugality level 506 (see FIG. 6) to determine the price outcome 602 associable with Joe's desired electronic books 102 A-N.

Similarly, and according to an illustrative example, Jane may desire Charles Dickens' novels, and in particular, Oliver Twist. Based on Jane's preferred and/or desired genre 706 and language 708, an electronic book profile 104 including historical fiction and period books may be associated with Jane. Subsequently, desired electronic books 102 A-N including Charles Dickens novels such as David Copperfield and Great Expectations may be presented to be downloaded by Jane. It will be appreciated that the tracking module (not shown) may work seamlessly with Jane's interest level 504 and frugality level 506 (see FIG. 6) to determine the price outcome 602 associable with Jane's desired electronic books 102 A-N.

According to another illustrative example, James may desire Fyodor Dostoyevsky novels, and in particular, Crime and Punishment. Based on James' preferred and/or desired genre 706 and language 708, an electronic book profile 104 including suspense and literary works may be associated with James. Subsequently, desired electronic books 102 A-N including Fyodor Dostoyevsky novels such as The Idiot and Brothers Karamazov may be presented to be downloaded by James. It will be appreciated that the tracking module (not shown) may work seamlessly with James' interest level 504 and frugality level 506 (see FIG. 6) to determine the price outcome 602 associable with James' desired electronic books 102 A-N.

Jack, on the other hand and according to another illustrative example, may desire biographies written by Walter Isaacson, and in particular, Steve Jobs. Based on Jack's preferred and/or desired genre 706 and language 708, an electronic book profile 104 including biography and technology-related electronic books may be associated with Jack. Subsequently, desired electronic books 102 A-N including biographies written by Walter Isaacson such as Einstein and Benjamin Franklin may be presented to be downloaded by Jack. It will be appreciated that the tracking module (not shown) may work seamlessly with Jack's interest level 504 and frugality level 506 (see FIG. 6) to determine the price outcome 602 associable with Jack's desired electronic books 102 A-N. The user 108 and other similar users may have different desires and/or preferences and the price outcome 602 may be adjusted based on the user 108's interest level 504 and/or frugality level 506, according to one or more exemplary embodiments.

It will be appreciated that the downloading of the desired electronic book 102 to an electronic device 404 of the user 108 may be based on a type of electronic device 404 of the user 108 such that the desired electronic book 102 may be presented for downloading in a file format compatible with the electronic device 404 of the user 108, according to one or more embodiments. Different electronic devices 404 may have varying requirements in terms of compatible and/or preferred file formats. The desired electronic book 102 may be automatically formatted based on the file format (e.g., a .pdf file format, an .epub file format, a .mobi file format etc.) most compatible and/or preferred by user 108's electronic device 404 (e.g., iPad®, Kindle®, Nook® etc.), according to one or more exemplary embodiments.

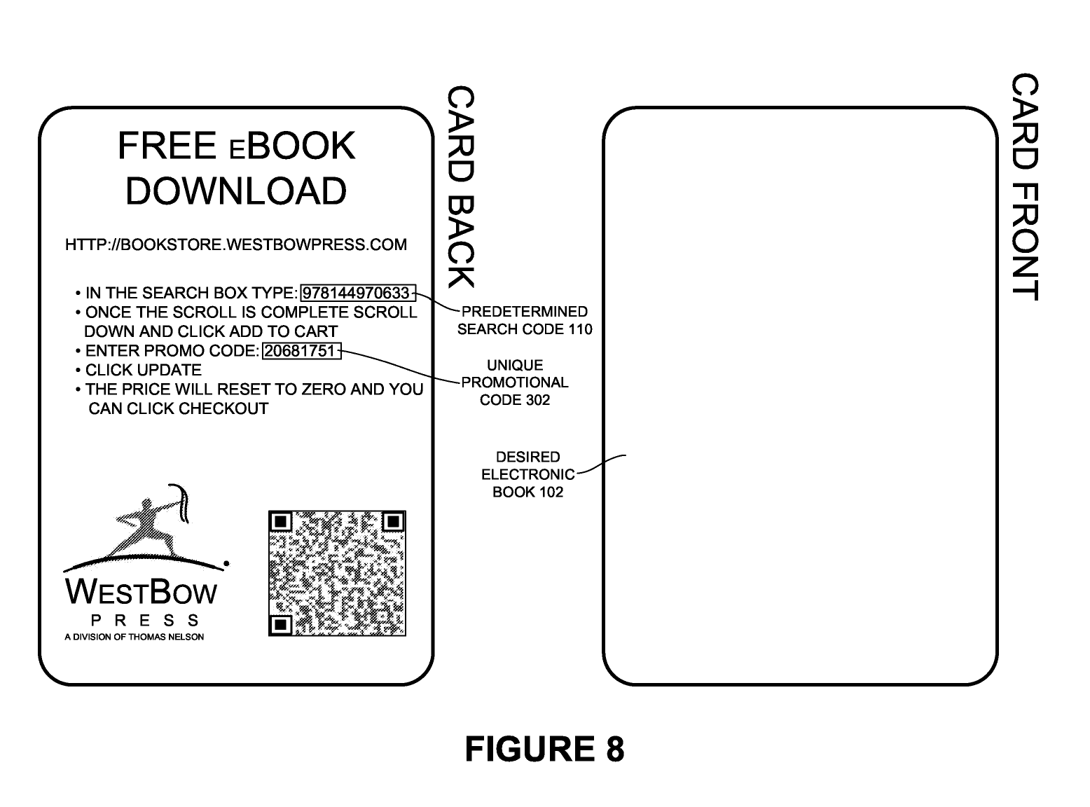

FIG. 8 illustrates a user-interface view of a promotional electronic book card (e.g., BookStub™ card) 800 with a predetermined search code 110 and a unique promotional code 302 to download a desired electronic book 102, according to one or more embodiments. The promotional electronic book card 800 may identify the author 702, the title 704 and/or the genre 706 of the desired electronic book 102 in addition to other source identifying information (e.g., language 708, country of origin etc.) of the desired electronic book 102, according to one or more embodiments. In one or more embodiments, promotional electronic book card 800 may present an internet/web link directing user 108 to visit a website (which may or may not be a mobile website) to download the desired electronic book 102.

According to one or more embodiments, promotional electronic book card 800 may include the predetermined search code 110 to be entered into a search box. Once the search is complete, user 108 may be instructed to scroll down and click “ADD TO CART” (to begin the delivery process of the desired electronic book 102). According to an illustrative embodiment, the user 108 may then be prompted to enter the unique promotional code 302 and the price may be updated and/or adjusted from a non-discount price 202 to a discount price 402 (e.g., which may be further adjusted based on user 108's interest level 504, frugality level 506 and upon user 108's subsequent interaction with a number of electronic book profiles 104 A-N etc.). The discount price 402 may then reset to zero (or any other amount based on price outcome 602) and the user 108 may click CHECKOUT to begin downloading his/her desired electronic book 102 on to his/her electronic device 404, according to one or more exemplary embodiments.

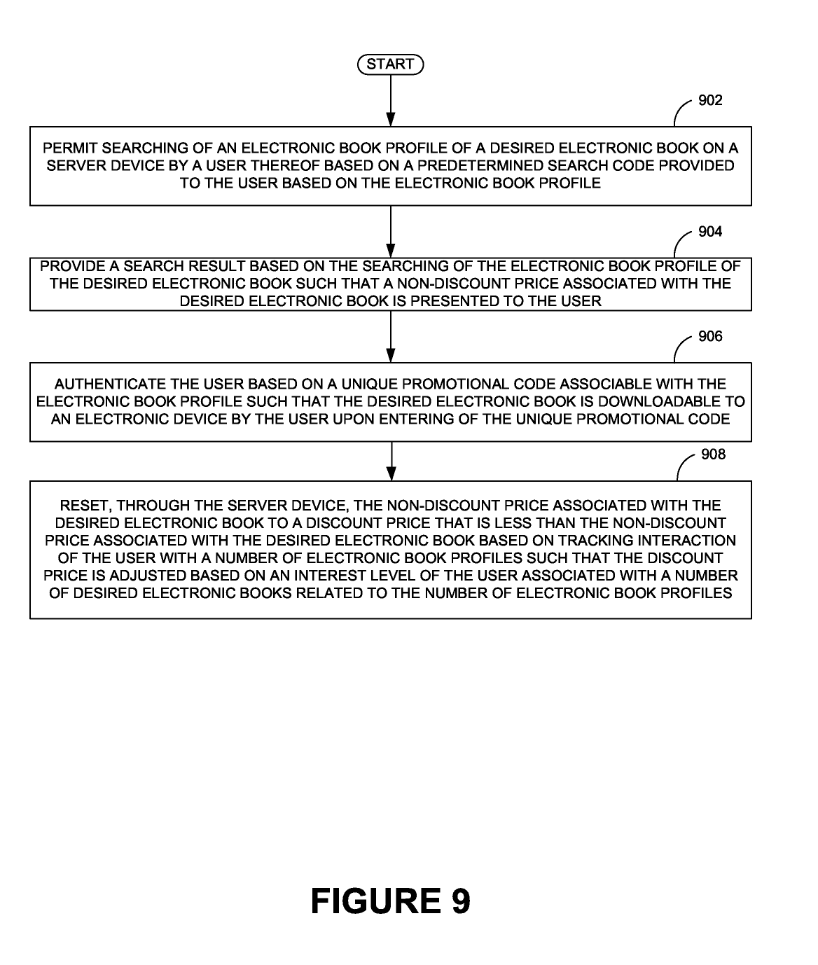

FIG. 9 shows a process flow diagram detailing the operations involved in a method of authentication and delivery of an electronic book, according to one or more embodiments. In one or more embodiments, operation 902 may involve permitting searching of an electronic book profile 104 of a desired electronic book 102 on a server device 106 by a user 108 thereof based on a predetermined search code 110 provided to the user 108 based on the electronic book profile 104. In one or more embodiments, operation 904 may involve providing, through server device 106, a search result based on the searching of the electronic book profile 104 of the desired electronic book 102 such that a non-discount price 202 is presented to the user 108.

In one or more embodiments, operation 906 may involve authenticating the user 108 based on a unique promotional code 302 associable with the electronic book profile 104 such that the desired electronic book 102 is downloadable to an electronic device 404 by the user 108 upon entering of the unique promotional code 302. In one or more embodiments, operation 908 may then involve resetting, through server device 106, the non-discount price 202 associated with the desired electronic book 102 to a discount price 402 that is less than the non-discount price 202 associated with the desired electronic book 102 based on tracking interaction of the user 108 with a number of electronic book profiles 104 A-N such that the discount price 402 is adjusted based on an interest level 504 of the user 108 associated with a number of desired electronic books 102 A-N related to the number of electronic book profiles 104 A-N.

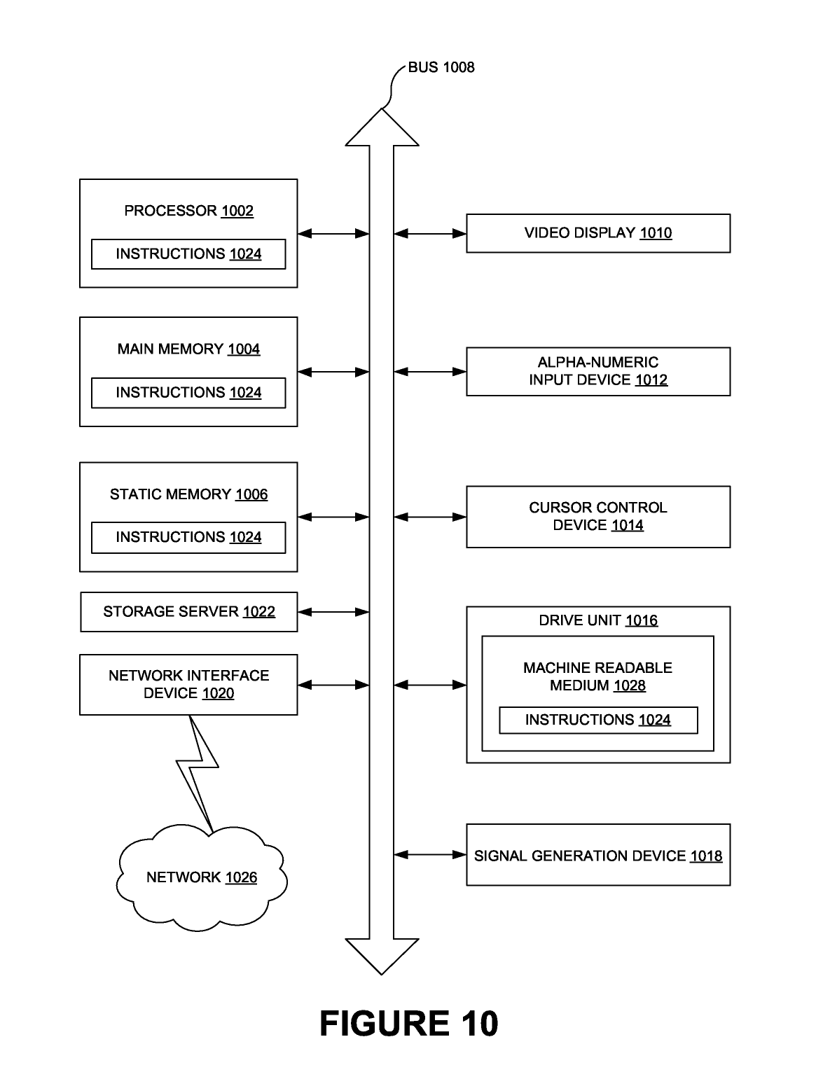

FIG. 10 shows a data processing system (e.g., electronic device 404) in which one or more operations disclosed herein may be performed. The processor 1002 may be a microprocessor, a state machine, an application specific integrated circuit, a field programmable gate array, etc. (e.g., Intel® Pentium® processor, ARM processor, etc.). The main memory 1004 may be a dynamic random access memory, a non-transitory memory, and/or a primary memory of a computer system. The static memory 1006 may be a hard drive, a flash drive, and/or other memory information associated with the data processing system. The bus 1008 may be an interconnection between various circuits and/or structures of the data processing system. The video display 1010 may provide graphical representation of information on the data processing system. The alpha-numeric input device 1012 may be a keypad, a keyboard, a virtual keypad of a touchscreen and/or any other input device of text (e.g., a special device to aid the physically handicapped).

The cursor control device 1014 may be a pointing device such as a mouse. The drive unit 1016 may be a hard drive, a storage system, and/or another longer term storage subsystem. The signal generation device 1018 may be a bios and/or a functional operating system of the data processing system. The network interface device 1020 may be a device that performs interface functions such as code conversion, protocol conversion and/or buffering required for communication to and from the network 1026. The machine readable medium 1028 may provide instructions on which any of the methods disclosed herein may be performed. The instructions 1024 may provide source code and/or data code to the processor 1002 to enable any one or more operations disclosed herein.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, several modules may be employed to execute the present embodiments. The search module, the price module, the authentication module, the discount module, the download module, the tracking module, and all other modules may be enabled using software and/or using transistors, logic gates, and electrical circuits (e.g., application specific integrated ASIC circuitry) such as a security circuit, a recognition circuit, a dynamic landmark circuit, an ignition event circuit, a store circuit, a transform circuit, an ICE circuit, and other circuits. The aforementioned modules may be executed through processor 1002 communicatively coupled to a memory (e.g., main memory 1004).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A server device comprising:
a memory; and
a processor communicatively coupled to the memory, the processor being configured to execute instructions associated with:
permitting searching of an electronic book profile of a desired electronic book on the server device by a user based on a predetermined search code provided to the user based on the electronic book profile;
providing a search result based on the searching of the electronic book profile of the desired electronic book such that a non-discount price associated with the desired electronic book is presented to the user;
authenticating the user based on a unique promotional code associable with the electronic book profile such that the desired electronic book is downloadable to an electronic device by the user upon entering of the unique promotional code; and
resetting the non-discount price associated with the desired electronic book to a discount price that is less than the non-discount price associated with the desired electronic book based on tracking interaction of the user with a plurality of electronic book profiles such that the discount price is adjusted based on an interest level of the user associated with a plurality of desired electronic books related to the plurality of electronic book profiles.

2. The server device of claim 1, wherein the processor is configured to execute instructions associated with locating fragments of the plurality of electronic book profiles based on a profile of the user such that a subsequent interaction with the user to track the interest level of the user is associable with the plurality of desired electronic books and modifying the fragments of the plurality of electronic book profiles based on the interest level of the user and the corresponding profile thereof.

3. The server device of claim 2, wherein the processor is configured to execute instructions associated with making an association between the non-discount price associated with the desired electronic book and a frugality level associable with the profile of the user such that the non-discount price associated with the desired electronic book is reduced prior to being presented to the user when the user subsequently interacts with the plurality of electronic book profiles.

4. The server device of claim 1, wherein the processor is configured to execute instructions associated with automatically populating the predetermined search code such that the unique promotional code is used to create a number of predetermined search codes associable with the plurality of electronic book profiles.

5. The server device of claim 1, wherein the processor is configured to execute instructions associated with permitting the downloading of the desired electronic book in a plurality of file formats associable with a plurality of electronic devices.

6. The server device of claim 1, wherein the processor is configured to execute instructions associated with tracking behavior of the user based on the interaction of the user with the plurality of electronic book profiles.

7. A method comprising:
permitting searching of an electronic book profile of a desired electronic book on a server device by a user thereof based on a predetermined search code provided to the user based on the electronic book profile;
providing, through the server device, a search result based on the searching of the electronic book profile of the desired electronic book such that a non-discount price associated with the desired electronic book is presented to the user;
authenticating the user based on a unique promotional code associable with the electronic book profile such that the desired electronic book is downloadable to an electronic device by the user upon entering of the unique promotional code; and
resetting, through the server device, the non-discount price associated with the desired electronic book to a discount price that is less than the non-discount price associated with the desired electronic book based on tracking interaction of the user with a plurality of electronic book profiles such that the discount price is adjusted based on an interest level of the user associated with a plurality of desired electronic books related to the plurality of electronic book profiles.

8. The method of claim 7, further comprising providing, through the server device, a capability to associate user behavior with at least one of an author, a title, a genre, an electronic book length, a complexity level, a text-to-image ratio, and a language of the desired electronic book such that the plurality of electronic book profiles matching the user behavior is presented to the user upon subsequent interaction of the user with the plurality of desired electronic books.

9. The method of claim 7, further comprising presenting the desired electronic book for download to the user in a file format compatible with the electronic device of the user.
